(19) United States
(12) Patent Application Publication
(10) Pub. No.: US 2002/0061781 A1
(43) Pub. Date: May 23, 2002

(54) Electronic game device, data processing method and storage medium for the same

(75) Inventor: Keisuke Tonomura, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/011,919

(22) Filed: Nov. 6, 2001

(30) Foreign Application Priority Data
Nov. 17, 2000 (JP) 2000-351430

(51) Int. Cl. A63F 13/00

(52) U.S. Cl. 463/43

(57) ABSTRACT

The present invention relates to an electronic game device, a data processing method and a storage medium for the same, which can execute an unexpected game certainly and rapidly. A shot image is obtained by a digital camera to transmit it to the electronic game device. In the electronic game device, at least one game character relating data selected from the group consisting of a name of a character, a characteristic of the character, a color of the character, an attribute of the character and a name of a parameter used in the game, is automatically created in accordance with the shot image. Thereby, a user can enjoy an unexpected game.

### BACKGROUND OF THE INVENTION

1. Field of the Invention

The present invention relates to an electronic game device, a data processing method and a storage medium for the same, which are useful in applying to each type of electronic apparatus, such as a digital camera, an electronic game apparatus or the like.

2. Description of Related Art

Recently, a portable game device in which an object to be shot is simply shot by using an electronic camera to display the shot image on a display section, has been known.

However, in case of this type of portable game device, although the portable game device is widely used among children because various image processing, such as a function of creating a montage image, a function of composing an image or the like, can be carried out, this portable game device cannot sufficiently satisfy user's desire that the user wants to play the game which gives an impression to the user and uses an unexpected image.

### SUMMARY OF THE INVENTION

An object of the present invention is to provide an electronic game device, a data processing method and a storage medium which are able to play an electronic game which gives an impression to a user and becomes unexpected by using a very simple structure.

In order to accomplish the above-described object, the electronic game device according to the present invention automatically creates at least one game character relating data selected from the group consisting of a name of a character appearing in a game, a characteristic of the character, a color of the character, an attribute of the character and a name of a parameter used in the game, in accordance with the shot image sent from the outside of the electronic game device.

### BRIEF DESCRIPTION OF THE DRAWINGS

FIG. 1 is a plan view showing the whole electronic game system according to the present embodiment;

FIG. 2 is the whole block diagram showing circuit structures of a digital camera and a portable game device which constitute the electronic game system;

FIG. 3 is a view showing a memory structure of the RAM disposed in the digital camera;

FIGS. 4A and 4B are views showing a memory structure of a hit point conversion ROM and that of an attribute and color conversion ROM;

FIGS. 5A and 5B are views showing a memory structure of a character name conversion ROM and that of a special skill name conversion ROM;

FIG. 6 is a view showing a memory structure of an attack ability conversion ROM;

FIG. 7 is a view showing a memory structure of a defense ability conversion ROM;

FIG. 8 is a view showing a memory structure of the RAM disposed in the portable game device;

FIGS. 9A, 9B and 9C are views showing display examples displayed on the display section in the digital camera;

FIG. 10 is a view showing the process for the general flow, which is carried out by the electronic game system in the present embodiment;

FIG. 11 is a view showing the process for shooting by the digital camera;

FIG. 12 is a view showing the process for transmitting a shot image to the game device;

FIG. 13 is a view showing the process for receiving a shot image by the game device;

FIG. 14 is a view showing the first half part of the process for creating an original character by using a shot image;

FIG. 15 is a view showing the second half part of the process for creating an original character by using a shot image;

FIG. 16A is a view showing a display example of a shot image soon after the shooting, and FIG. 16B is a view showing a display example of an original character soon after the creation thereof;

FIG. 17 is a view showing a display example of a normal game according to the present embodiment;

FIG. 18 is a view showing a display example of a game using an original character, according to the present embodiment;

FIG. 19 is a view showing another embodiment of the present invention;

FIG. 20 is a view showing further another embodiment of the present invention; and

FIG. 21 is a view showing further another embodiment of the present invention.

### PREFERRED EMBODIMENTS OF THE INVENTION

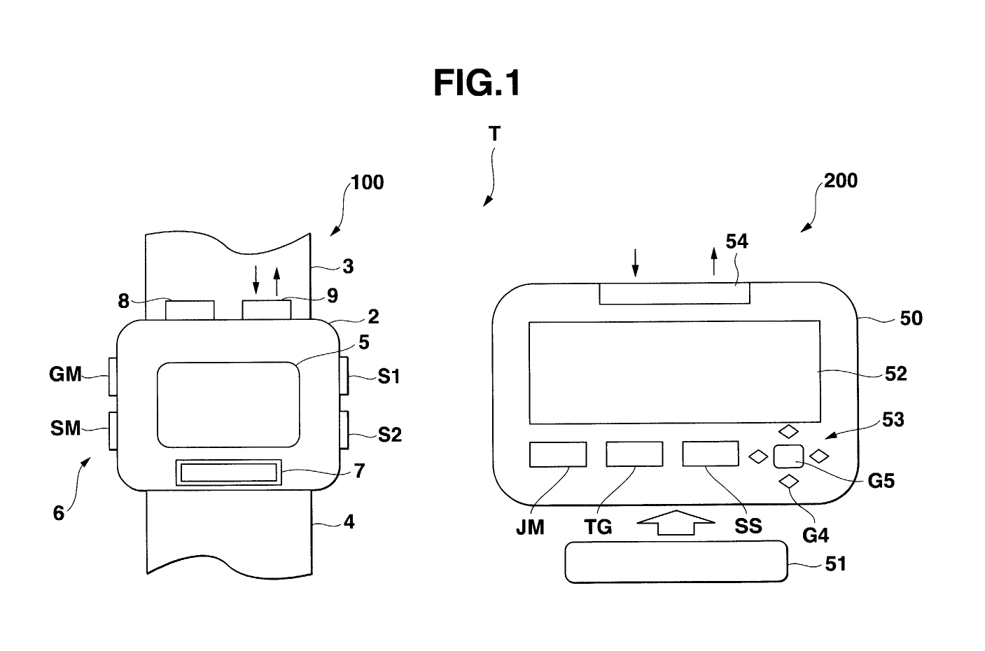

Hereinafter, an embodiment of the electronic game system according to the present invention will be explained in detail with reference to FIGS. 1 to 18.

FIG. 1 shows the whole system of the electronic game system according to the present embodiment.

As shown in FIG. 1, the electronic game system T comprises a wrist watch type of digital camera 100 and a portable game device 200.

The wrist watch type of digital camera 100 comprises a camera part 2 and wrist bands 3 and 4 extending from the camera part 2. The camera part 2 comprises a display section 5 on which a shot image or various types of data are displayed, an input section 6 for being operated by a user, and the like. The input section 6 comprises key input units Si and S2 provided on the side surface of the camera part 2, a shutter switch 7 of the camera, which is operated in the shooting, and the like. On a front end portion of the camera part 2, which is on the wrist band 3 side, a shooting section 8 and an infrared communication section 9 are provided apart from each other at a predetermined interval. The shooting section 8 shoots an object to be shot, by the switch operation of the shutter switch 7. The infrared communication section 9 transmits a shot image corresponding to the shot object, to the portable game device 200 with infrared rays in accordance with the IrDA standard.

On the other hand, the portable game device 200 comprises a game part 50 and an external ROM 51 which is attachable to and detachable from the game part 50. The game part 50 comprises a display section 52 on which the shot image transmitted from the above-described wrist watch type of digital camera 100 or various types of data are displayed, an input section 53 for being operated by a user, an infrared communication section 54 for communicating the shot image or the like with the wrist watch type of digital camera 100, and the like. The input section 53 comprises each type of operation switch G4, G5, JM, TG and the like.

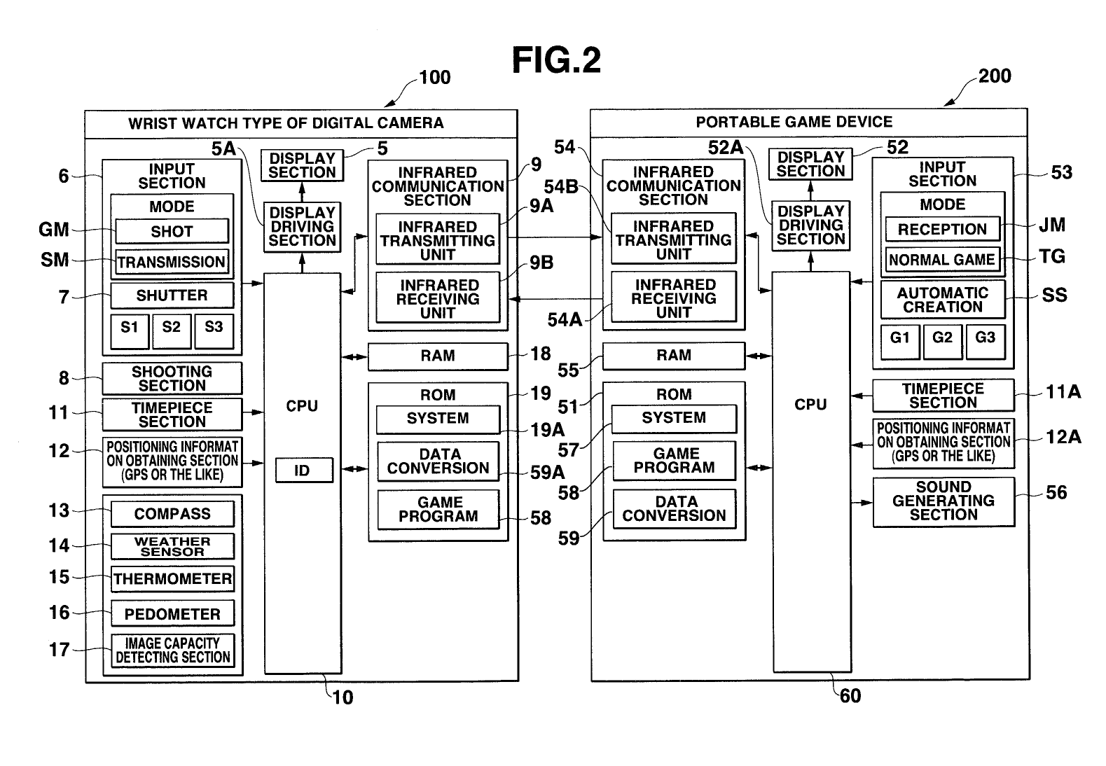

FIG. 2 is the whole block diagram showing circuit structures of a digital camera 100 and a portable game device 200 which constitute the above-described electronic game system.

A CPU 10 for controlling the whole of the digital camera 100, is connected with the display section 5, the input section 6, the shooting section 8, and the infrared communication section 9. Further, the CPU 10 is connected with a timepiece section 11, a positioning information obtaining section 12, a compass 13, a weather sensor 14, a thermometer 15, a pedometer 16, an image capacity detecting section 17, a RAM 18 and a ROM 19.

The infrared communication section 9 comprises an infrared transmitting unit 9A and an infrared receiving unit 9B.

The timepiece section 11 indicates the present time or measures the elapsed time and the like. The positioning information obtaining section 12 grasps the current position of the digital camera 100 in accordance with a GPS satellite, a beacon, FM multiplex broadcasting or the like. The compass 13 detects a current direction of the digital camera 100. The weather sensor 14 detects the weather from the condition, such as the current atmospheric pressure, rain, snow and the like. The thermometer 15 detects the current temperature. The pedometer 16 measures the number of steps by counting the number of walking signals detected by an incorporated vibration sensor or the like in accordance with the walking of a user. The image capacity detecting section 17 detects the data capacity of the shot image. The timepiece section 11, the positioning information obtaining section 12, the compass 13, the weather sensor 14, the thermometer 15, the pedometer 16 and the image capacity detecting section 17 function as environment data.

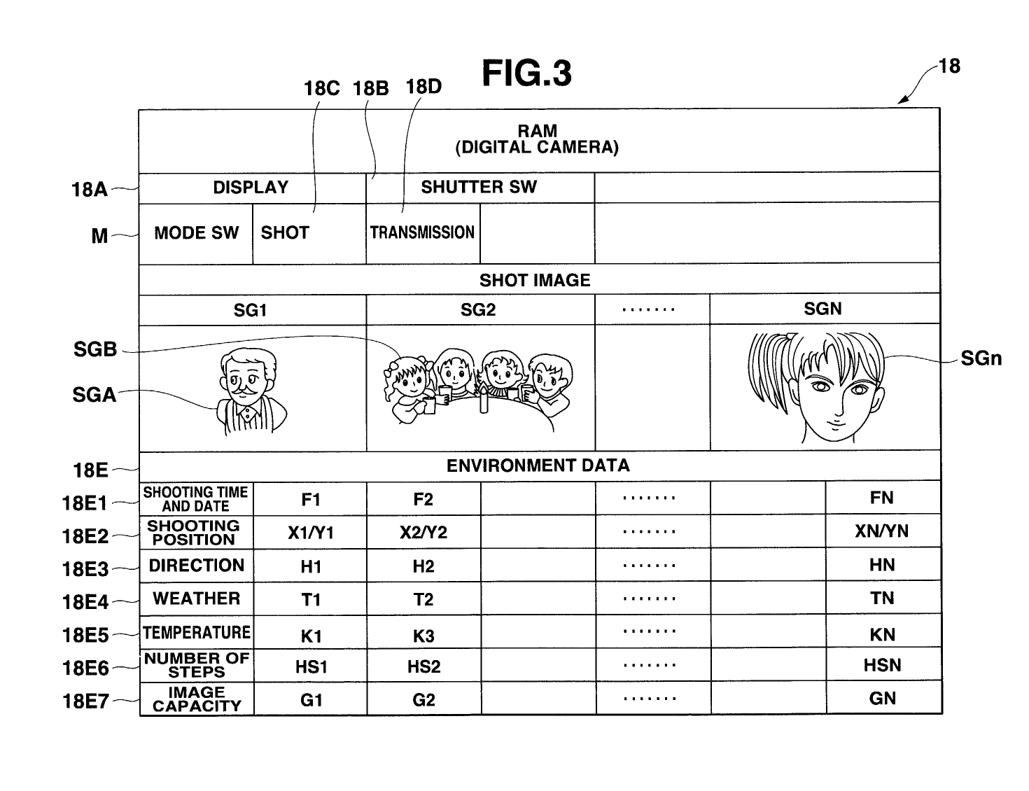

As shown in FIG. 3, the RAM 18 comprises a plurality of areas for storing various types of images and data which are used in the digital camera 100.

For example, an area 18A for display stores an image and the like to be displayed on the display section 5 therein. An area 18B for shutter switch stores a data for indicating whether the shutter switch 7 is operated. In a plurality of areas M for mode switch, an area 18C for shot image stores a data for indicating whether a shot image mode switch GM for shooting an object to be shot is operated. An area 18D for transmission stores a data for indicating whether a transmission mode switch SM for transmitting a shot image to the outside is operated. A plurality of areas SGl to SGN for shot image store shot images which are shot by a user.

A plurality of areas 18E for environment data store each environment data, such as shooting time and date and the like. In the areas 18E for environment data, an area 18E1 for shooting time and date stores the shooting time and date indicated by the timepiece section 11. An area 18E2 for shooting position stores a positioning data corresponding to the current position, which is grasped by a GPS satellite, a beacon, FM multiplex broadcasting or the like. An area 18E3 for direction stores the current direction of the digital camera 100, which is detected by the compass. An area 18E4 for weather stores the weather relating to the conditions of the current atmospheric pressure, rain, snow and the like, which is detected by the weather sensor 14. An area 18E5 for temperature stores the current temperature detected by the thermometer 15. An area 18E6 for the number of steps stores the number of steps of a user, which is measured by the pedometer 16. An area 18E7 for image capacity detection stores the data capacity of a shot image, which is detected by the image capacity detecting section 17.

The term “shooting time and date” is a concept relating to time and date, such as morning, daytime and night (each time slot in a day), hour, minute and second (time), Oct. 30, 2000 (year, month and day), spring, summer fall and winter (seasons in a year) or the like. The term “shooting position” is a concept relating to position, such as longitude 100° east and latitude 200° (latitude and longitude), area, country, region or the like. The term “shooting direction” is a direction in which the shooting section of the digital camera 100 is directed, and is a concept including not only east, west north and south, but also an angle at which the shooting section of the digital camera 100 is directed to the sky and the ground. The term “weather” is a concept including not only the weather at the shooting time, but also the weather, for example, the weather of the day for shooting, the weather before or after the day or the like. The term “temperature” is a concept including not only the temperature at the shooting time, but also the temperature, for example, the temperature of the day for the shooting, the temperature before or after the day or the like. The term “number of steps” is a concept including not only the number of steps till the shooting, but also the number of steps, for example, the number of steps on the day for the shooting, the total number of steps from several days ago, or the like. The term “data capacity of an image” is a concept including not only the data capacity of each shot image, but also the data capacity of all of the shot images.

The ROM 19 comprises a system ROM 19A. The system ROM 19A stores a program for controlling the whole system of the digital camera 100, and various types of data.

On the other hand, like the digital camera 100, in the portable game device 200, not only the display section 52, the input section 53 and the infrared communication section 54 but also an external ROM 51, a RAM 55 and a sound generating section 56 are connected with the CPU 60 for controlling the whole portable game device 200.

The external ROM 51 comprises a system ROM 57 having the same function as the above-described system ROM 19, a game program ROM 58 for storing a game program data, and a data conversion ROM 59 for converting a data into a predetermined data.

The game program ROM 58 stores a program data (including the current game proceeding contents, various type of parameters relating to a character appearing the game, a name of an image to be composed, a coordinate data of the composed part and the like) which is the game contents used in the portable game device 200.

The data conversion ROM 59 further comprises a hit point conversion ROM 60, a character attribute and color conversion ROM 61, a character name conversion ROM 62, a special skill conversion ROM 63, an attack ability conversion ROM 64 and a defense ability conversion ROM 65.

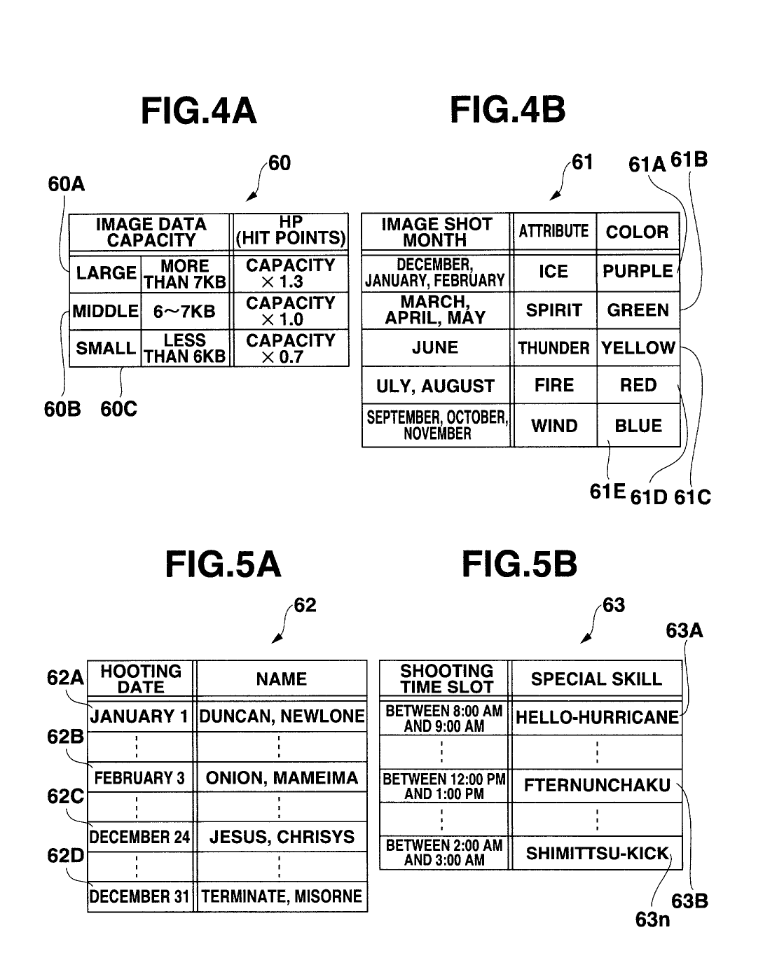

The hit point conversion ROM 60 is a ROM which determines the relation between the size of the data capacity of a shot image and the hit point of a character in a conversion table form as shown in FIG. 4A. For example, in each area 60A to 60D showing each item “large” (in case of the data capacity of more than 7 KB), “middle” (in case of the data capacity having the range of 6 to 7 KB) and “small” (in case of the data capacity of less than 6 KB) of “the size of the data capacity of a shot image”, each “equation” for determining the “hit points”, which is “capacity×1.3” (in case of the “large”), “capacity×1.0” (in case of the “middle”) and “capacity×0.7” (in case of the “small”), is stored by relating the “equations” to the size of the data capacity of a shot image.

The character attribute and color conversion ROM 61 is a ROM which determines the relation between the image shooting month of the shot image and the attribute and color of a character in a conversion table form as shown in FIG. 4B. For example, in each area 61A to 61E showing each item “December, January, February”, “March, April, May”, “June”, “July, August”, and “September, October, November” of the “image shooting month”, each “attribute” of a character, which is “ice”, “spirit”, “thunder”, “fire” and “wind” and each “color” of a character, which is “purple”, “green”, “yellow”, “red” and “blue” are stored by relating the “attribute” and the “color” to the image shooting month.

The character name conversion ROM 62 is a ROM which determines the relation between the image shooting month and day of the shot image and the name of a character in a conversion table form as shown in FIG. 5A. For example, in each area 62A to 62n showing each item “January 1”, . . . , “February 3”, . . . , “December 24”, . . . , and “December 31”, of the “image shooting month and day”, each “name” of a character, which is “Duncan, Newlone”, . . . , “Onion, Mameima”, . . . , “Jesus, Chrisys”, . . . , and “Terminate, Misorne”, is stored by relating the “name” to the “image shooting month and day”.

The special skill conversion ROM 63 is a ROM which determines the relation between the image shooting time slot of the shot image and the special skill of a character in a conversion table form as shown in FIG. 5B. For example, in each area 63A to 63n showing each item “Between 8:00 AM and 9:00 AM”, “Between 12:00 PM and 1:00 PM” and “Between 2:00 AM and 3:00 AM”, of the “image shooting time slot”, each “special skill” performed by a character, which is “Hello-Hurricane”, . . . , “Afternunchaku”, . . . , and “Ushimittsu-Kick”, is stored by relating the “special skill” to the “image shooting time slot”.

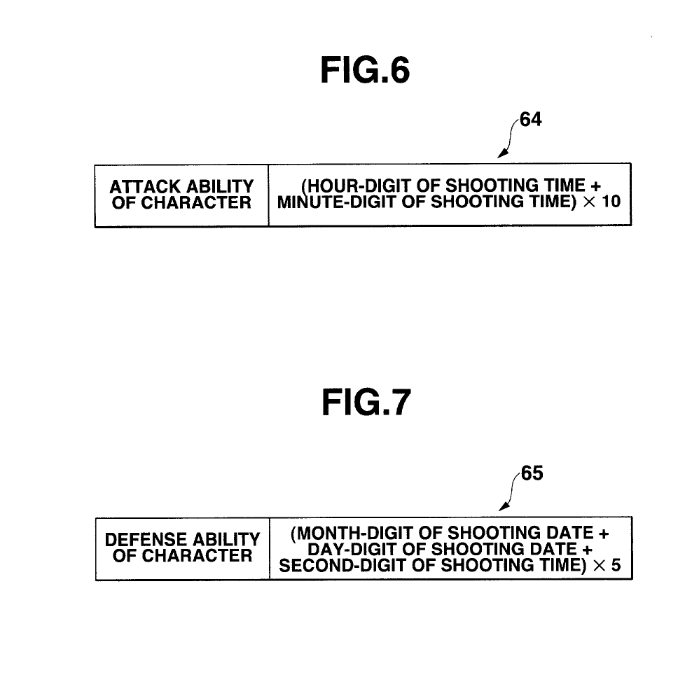

The attack ability conversion ROM 64 is a ROM which determines the relation between the attack ability of a character and the equation for calculating the attack ability in a conversion table form as shown in FIG. 6. For example, the “attack ability of a character” is stored by relating it to the equation “(Hour-digit of the shooting time+Minute-digit of the shooting time)×coefficient 10”.

The defense ability conversion ROM 65 is a ROM which determines the relation between the defense ability of a character and the equation for calculating the defense ability in a conversion table form as shown in FIG. 7. For example, the “defense ability of a character” is stored by relating it to the equation“(Month-digit of the shooting date+Day-digit of the shooting date+Second-digit of the shooting time)×coefficient 5”.

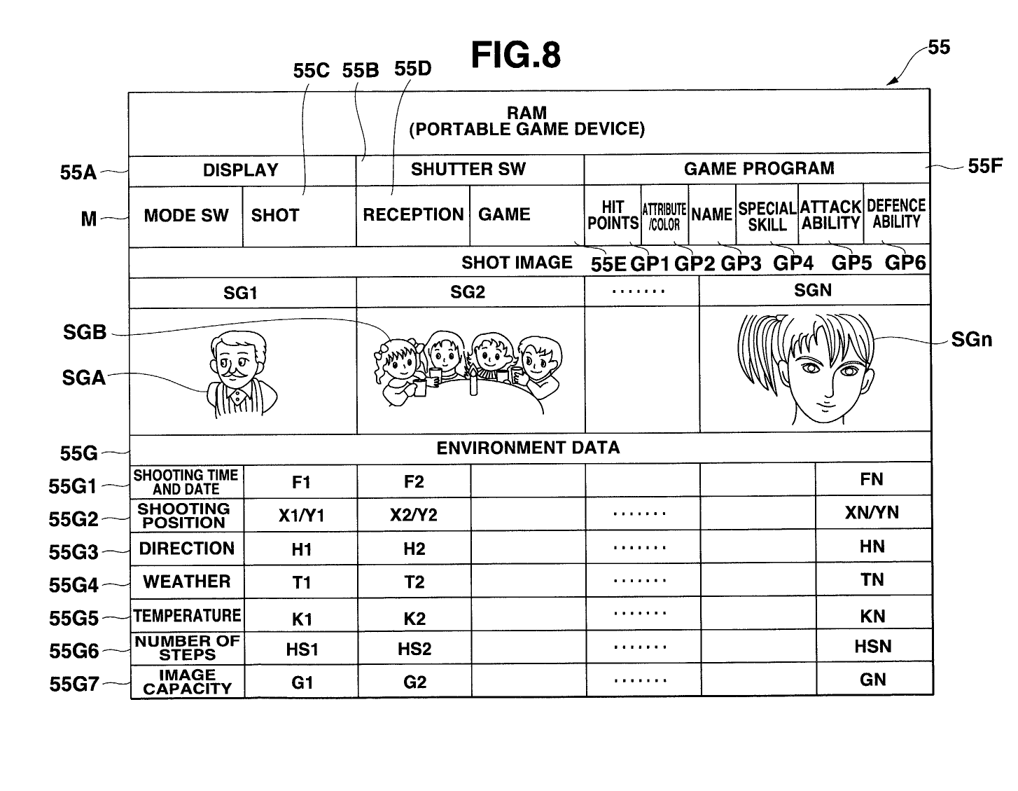

As shown in FIG. 8, the RAM 55 comprises a hit point area GP1, a character attribute and color conversion area GP2, a character name area GP3, a special skill conversion area GP4, an attack ability conversion area GP5 and a defense ability conversion area GP6. Further, the RAM 55 comprises a program area 55F for storing a game program data loaded from the game program ROM in the external ROM, an area 55A for display, which is the same as the area of the RAM 18 disposed in the above-described digital camera 100, a plurality of areas SG1 to SGN for shot image, which store the shot images transmitted from the digital camera 100, a plurality of areas 55G for environment data, which store the environment data, such as the shooting time and date and the like, which are transmitted from the digital camera 100, and the like.

The areas for environment data, comprise an area 55G1 for shooting time and date, an area 55G2 for shooting position, an area 55G3 for direction, an area 55G4 for weather, an area 55G5 for temperature, an area 55G6 for the number of steps, and an area 55G7 for image capacity detection.

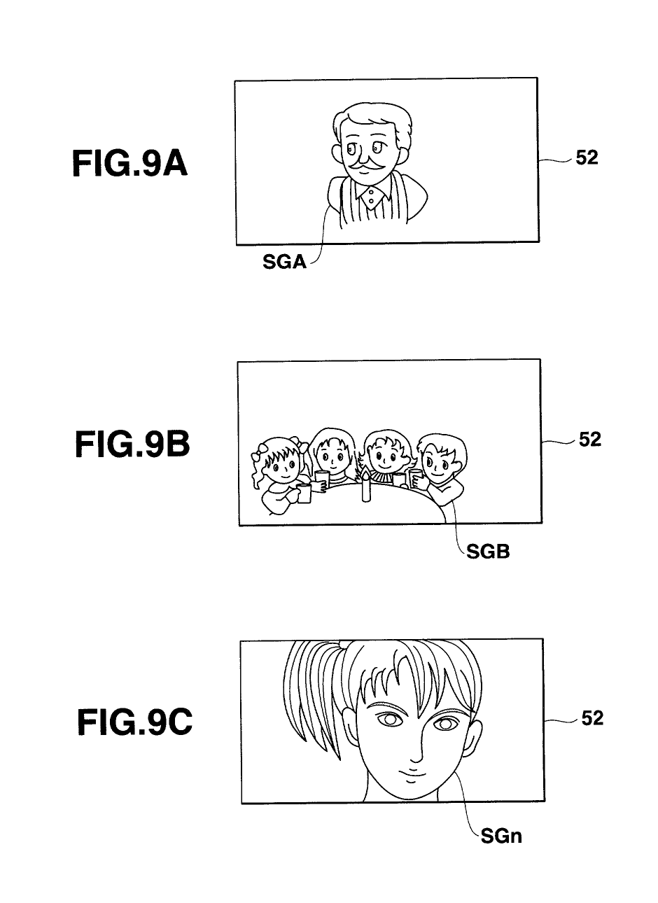

FIGS. 9A, 9B and 9C show display examples displayed on the display section 52 in the portable game device 200.

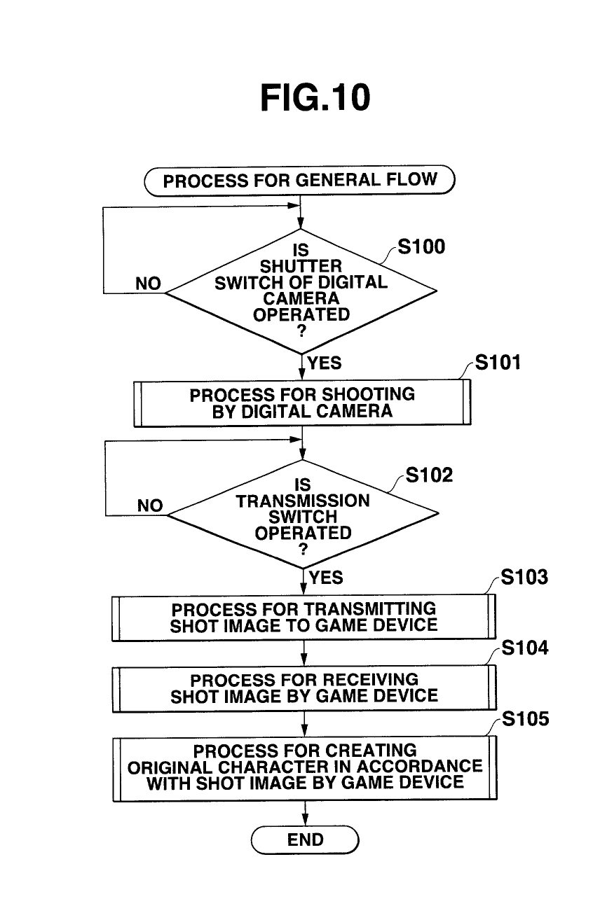

FIG. 10 shows the process for the general flow in the present embodiment.

After a power supply of the digital camera 100 and that of the game device 200 are switched on, firstly, when the shutter switch 7 of the digital camera 100 is operated (S100), the process for shooting by the digital camera 100 is carried out (S101). When the transmission mode switch SM of the digital camera 100 is operated (S102), the process for transmitting a shot image from the digital camera 100 carrying out the shot process to the game device 200 is carried out (S103). After the process for transmitting a shot image is carried out, the process for receiving a shot image by the game device 200 is carried out (S104). After the process for receiving a shot image is carried out, the process for creating an original character in accordance with the shot image by the game device 200 is carried out (S105). When the process for creating an original character in accordance with the shot image is finished, the general flow is ended.

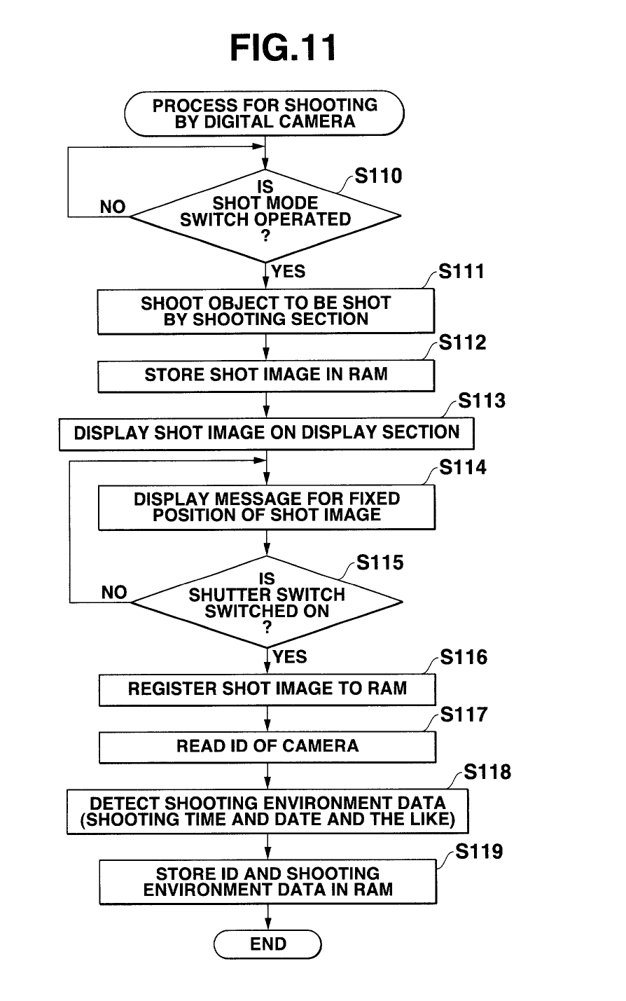

FIG. 11 shows a flow of “process for shooting by digital camera” in the above-described general flow.

After a power supply of the digital camera 100 is switched on, the flow of “process for shooting by digital camera” is started.

Firstly, the CPU 10 of the digital camera 100 judges whether the shot mode switch GM is operated (S110). When it is judged that the shot mode switch GM is operated in the step S110, an object to be shot is shot by the shooting section 8 (S111). Then, the CPU 10 reads the shot image (including a scene image) corresponding to the shot object. The read shot image is stored in one of the shot image areas SG1 to SGN of the RAM 18 (S112). Then, as shown in FIG. 9A, the shot image SGA is displayed on the display section 5 by the display driving section SA (S113). In order to let a user judge whether the shot image SGA is in a fixed position of the display screen, the message MS “fixed position?” is displayed on the upper portion of the display section 52 (S114) The user adjusts the positional relation between an object to be shot and the shooting section 8 so that the shot image SGA is in the fixed position (for example, in a frame line W1 formed in a rectangle shape, which is fixedly displayed on a center portion of the display section 52) of the display screen according to the message MS.

After the shot image SGA is in the fixed position of the display screen, the CPU 10 judges whether the shutter switch 7 is operated (S115). When it is judged that the shutter switch 7 is operated, the CPU 10 reads the shot image SGA to substitutionally store the read shot image SGA in the shot image area SGl of the RAM 18 as a definite registered shot image SGA (S116).

Then, an ID (an identification number or a specific number assigned to the camera, for example, a serial number of the camera 100 or the like) of the camera 100 is read (S117). The shooting time and date, the shooting position, the direction, the weather, the temperature, the number of steps and the image capacity, which are the shooting environment data are detected by various types of sensors, such as the timepiece section 11, the positioning information obtaining section 12, the compass 13, the weather sensor 14, the thermometer 15, the pedometer 16 and the image capacity detecting section 17, respectively (S118). The detected shooting environment data are read and then the ID and the shooting environment data are stored in a plurality of areas 18E for environment data, of the RAM 18 (S119). Then, this flow is ended.

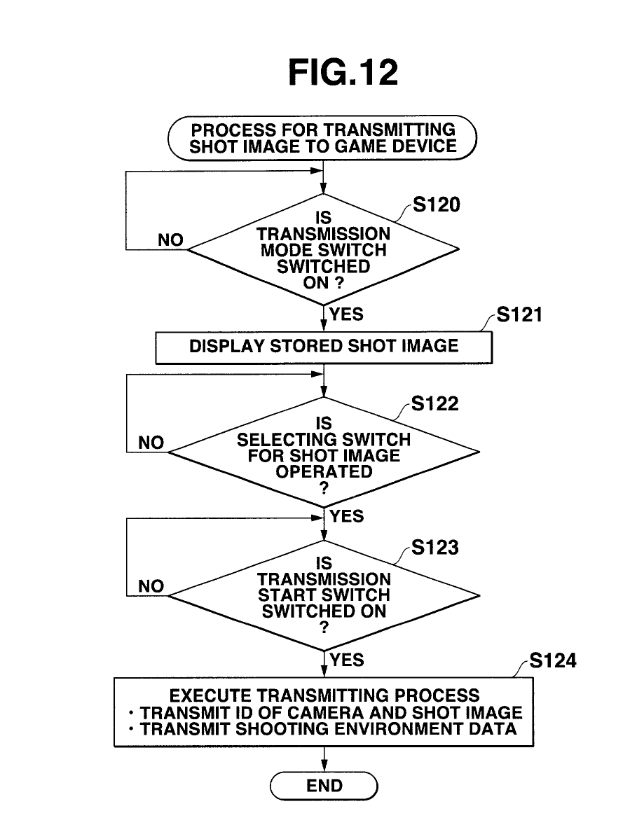

FIG. 12 shows a flow of “process for transmitting shot image to game device” in the above-described general flow.

Firstly, the CPU 10 of the digital camera 100 judges whether the transmission mode switch SM is switched on (S120). When it is judged that the transmission mode switch SM is switched on in the step S120, all of the stored shot images are displayed on the display section 5 in a list or selectively (S121). Thereby, the shot images which have been shot can be confirmed with an eye.

Next, the CPU 10 judges whether the image selecting switch S1 for selecting all of the shot images or some of the shot images is operated (S122). Further, the CPU 10 judges whether the transmission start switch S2 is switched on (S123). As a result, when it is judged that the transmission start switch S2 is switched on, the transmitting process for the shot image and the like is executed (S124). In the transmitting process, not only the ID of the camera 100 and the shot images, but also the shooting environment data, such as the shooting time and date, the shooting position, the weather, the temperature, the direction and the like, are transmitted. Then, this flow is ended.

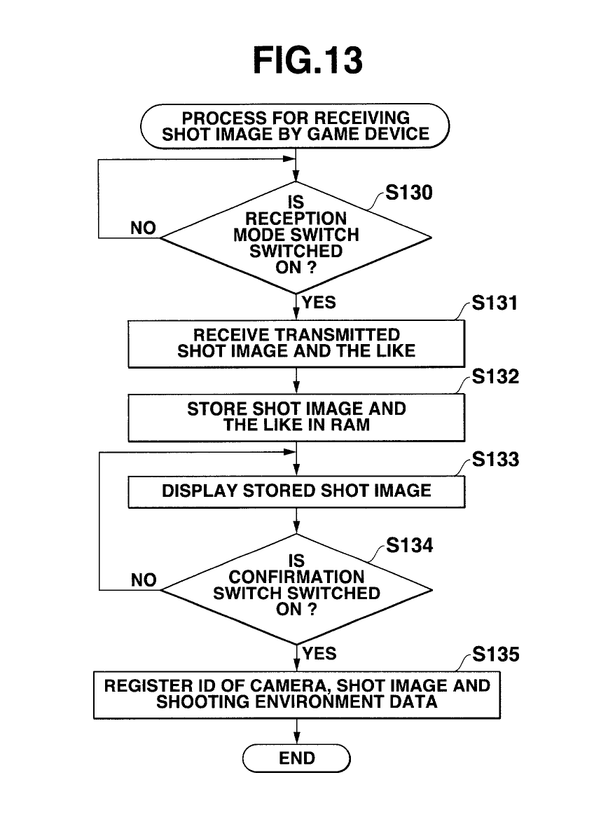

FIG. 13 shows a flow of “process for receiving shot image by game device” in the above-described general flow.

Firstly, the CPU 10 of the digital camera 100 judges whether the reception mode switch JM is switched on (S130). When it is judged that the reception mode switch JM is switched on in the step S130, the shot images (including the ID of the camera 100 and the shooting environment data) and the like, which are transmitted from the digital camera 100 are received to store the transmitted shot image and the like in the area for shot image and the like of the RAM 55 (S132). The stored shot images are displayed on the display section 52 by the display driving section 52A (S133). Thereby, the shot images which have been shot can be confirmed with an eye.

Next, the CPU 10 judges whether the confirmation switch G5 is operated (S134). As a result, after it is judged that the confirmation switch G5 is operated, the shot images and the like are registered as shot images which are finally decided (S135). Then, this flow is ended.

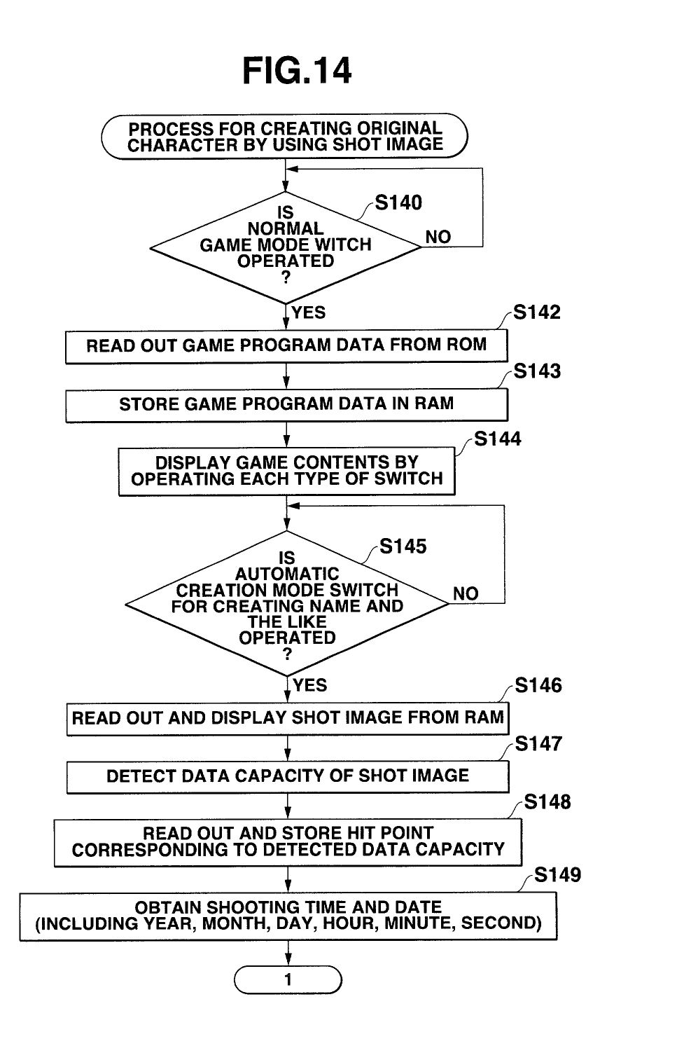

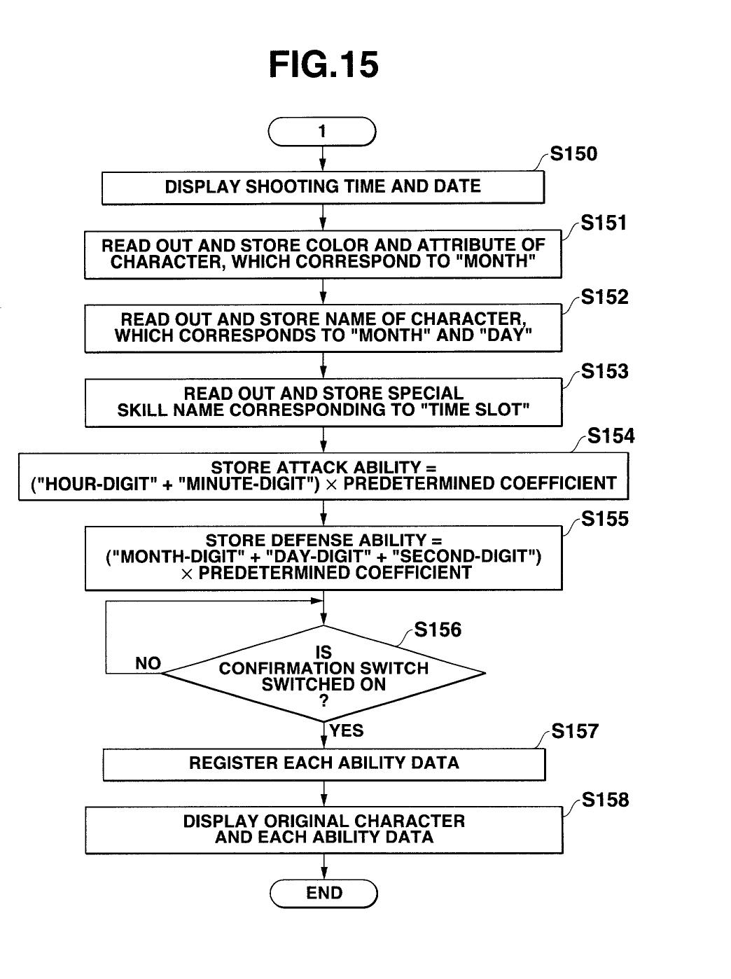

FIG. 14 shows the first half part of a flow of “process for creating original character by using shot image with game device” in the above-described general flow. FIG. 15 shows the second half part of a flow of “process for creating original character by using shot image with game device” in the above-described general flow.

This process for creating an original character is one for automatically creating a name and the like of a character appearing in the game, before the game or during the game.

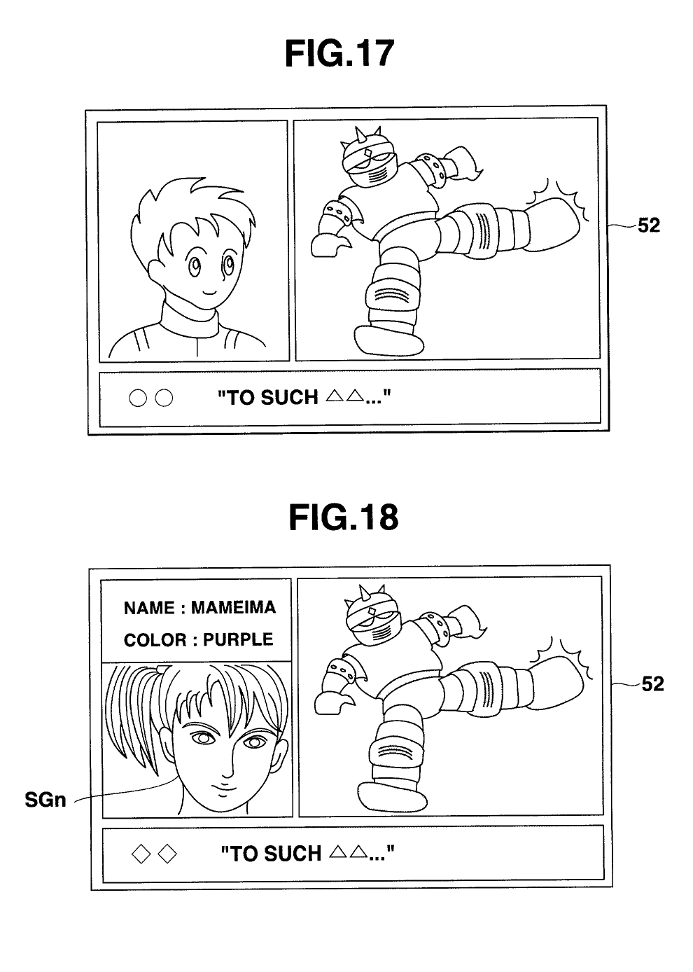

Firstly, the CPU 60 of the game device judges whether the normal game mode switch TG is operated (S140). As a result, it is judged that the normal game mode switch TG is operated, the game program data is read out from the game program ROM 58 (S142). The read out game program data is stored in the game program area 55F of the RAM 55 (S143). Then, when various types of switches G4 and the like are operated, as shown in FIG. 17, the game contents are displayed on the display section 52 in accordance with these operations and the game program data (S144).

While the game is displayed, the CPU 60 of the game device judges whether the automatic creation mode switch for creating a name and the like is switched on (S145). When it is judged that the automatic creation mode switch for creating a name and the like is switched on, the shot image to be used as an original character is read out from one of a plurality of areas SG1 to SGN, of the RAM 55 to display the read out shot image on the display 52 (S146). Then, the data capacity of the read out shot image (for example, a shot image SGn of a person as shown in FIG. 9C) is detected (S147).

The HP (hit point) corresponding to the detected data capacity is read out from the hit point conversion ROM 60 to store the hit point in the hit point area GP1 (S148).

Next, the shooting time and date (including year, month, day, hour, minute and second) are obtained from the RAM 55 (S149). The shooting time and date are displayed on the display section 52 (S15O). Then, the color of a character and the attribute of a character, which correspond to “month” of the obtained shooting time and date, are read out from the attribute and color conversion ROM 61 in order to store the color and the attribute in the character attribute and color conversion area GP2 (S151).

The name of a character, which corresponds to “month” and “day” of the shooting time and date obtained from the RAM 55, is read out from the character conversion ROM 62 in order to store the name in the name area GP3 (S152).

The special skill name corresponding to “time slot” of the shooting time and date obtained from the RAM 55, is read out from the special skill name conversion ROM 63 in order to store the special skill name in the special skill name area GP4 (S153).

The attack ability corresponding to the product of a predetermined coefficient multiplied by “hour-digit” +“minute-digit” of the shooting time and date obtained from the RAM 55, is read out from the attack ability conversion ROM 64 in order to store the attack ability in the attack ability conversion area GP5 (S154).

Further, the defense ability corresponding to the product of a predetermined coefficient multiplied by “month-digit”+“day-digit”+“second-digit” of the shooting time and date obtained from the RAM 55, is read out from the defense ability conversion ROM 65 in order to store the defense ability in the defense ability conversion area GP6 (S155).

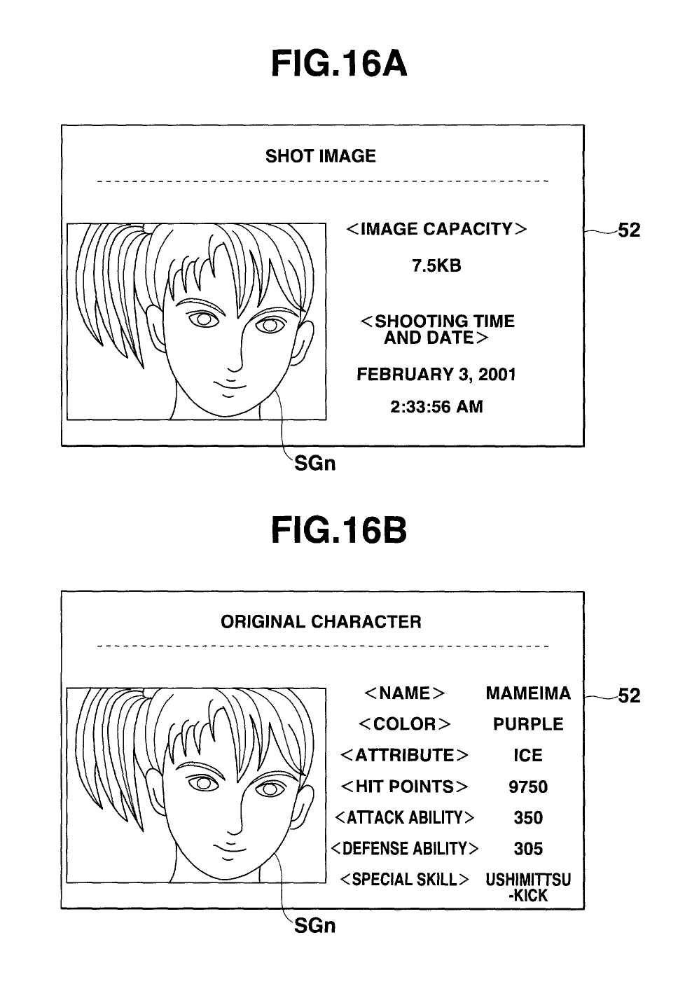

Then, it is judged whether the confirmation switch G5 is switched on (S156). When it is judged that the confirmation switch G5 is switched on in the step S156, the decision and the register of each ability data in each area GP1 to GP6, are finished. Then, as shown in FIG. 16B and FIG. 18, the name, the hit points and the like are displayed with the shot image SGA . . . of an original character on the display section 52 (S157). Then, this flow is ended.

For example, when the “image capacity” and the like, of the “shot image” obtained from the RAM 55 are detected, the “image capacity” is “7.5 KB”, and the “shooting time and date” are “Feb. 3, 2001” and “2:33:56 AM”.

In this case, the “name” is “Mameima” because the “month and day, of the shooting time and date” is “February 3”.

The “color” is “purple” because the “month of the shooting time and date” is “February”.

The “attribute” is “ice” because the “month of the shooting time and date” is “February”.

The “hit point” is “7500×1.3=9750” because the “data capacity of the image” is “7500”.

The “attack ability” is “(2+33)×10=350” because the “time of the shooting time and date” is “2:33”.

The “defense ability” is “(2+3+56)×5=305” because the “month, day and second, of the shooting time and date” are “February 3 and 56 seconds”.

The “special skill name” is “Ushimittsu-Kick” because the “time slot of the shooting time and date” is “between 2:00 AM and 3:00 AM”.

Therefore, as an original character, the shot image, an “image SGn of a woman's face” is displayed on the display section 52. The “name” of the character, “Mameima” is displayed. The “color” of the character, “purple” is displayed. The “attribute” of the character, “ice” is displayed. The “hit point” of the character, “9750” is displayed. The “attack ability” of the character, “350” is displayed. The “defense ability” of the character, “305” is displayed. The “special skill name” of the character, “Ushimittsu-Kick” is displayed.

In this embodiment, at least one game character relating data selected from the group consisting of a name of a character appearing in a game, a characteristic of the character, a color of the character, an attribute of the character and a name of a parameter used in the game, can be automatically created in accordance with the data capacity, the shooting time and date and the like, of the stored shot image. Therefore, the troublesome problem that a user inputs a name and the like for a character, can be previously prevented. Further, a name of the character appearing in the game, which is unexpected for a user, and the like, can be determined certainly and rapidly.

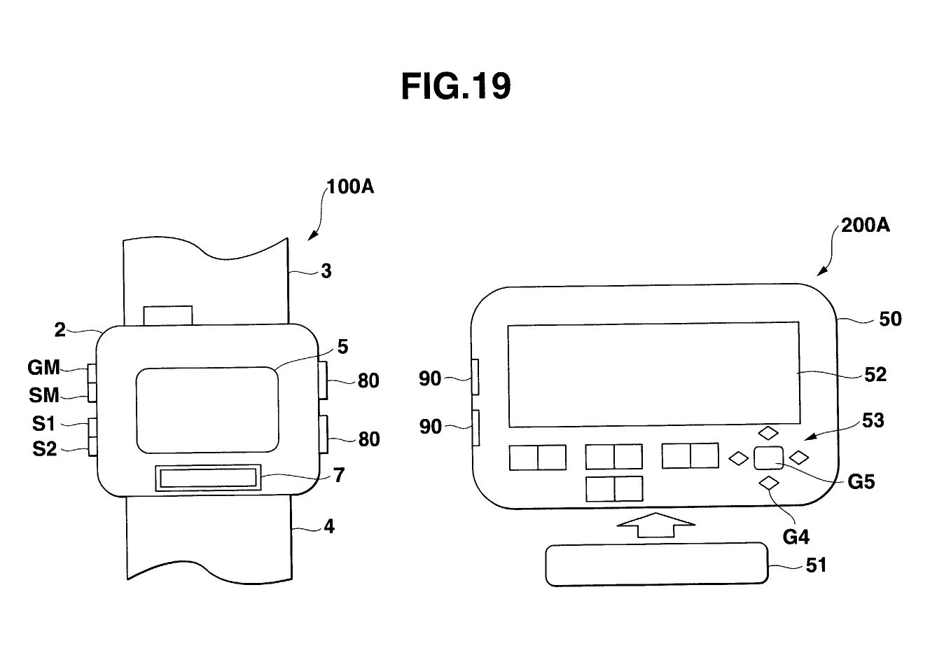

FIG. 19 shows another embodiment of the present invention. In FIG. 19, instead of the above-described infrared communication system, a communication system which is used by connecting a plurality of terminals, is adopted. Two external terminals 80 and 80 are provided on the digital camera 100A. Two external terminals 90 and 90 which are connected with the external terminals 80 and 80 are provided on the game device 200A. After the external terminals 80 and 80 are connected with the external terminals 90 and 90 respectively, a shot image which is shot by the digital camera 100A is transmitted to the game device 200A via the external terminals 80 and 80 and the external terminals 90 and 90. At least one game character relating data selected from the group consisting of a name of a character, a characteristic of the character, a color of the character, an attribute of the character and a name of a parameter used in the game, is automatically created and displayed in accordance with the transmitted shot image, like the above-described embodiment.

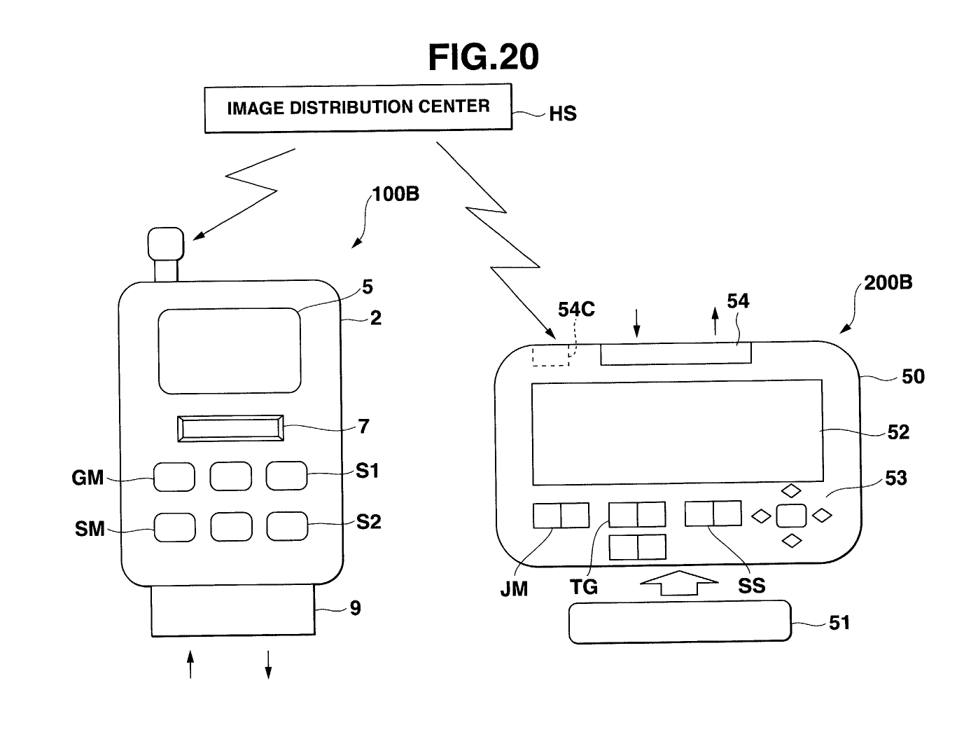

FIG. 20 shows further another embodiment of the present invention. In the above-described embodiment, the shot image which is shot by the shooting section 8 of the digital camera 100 is transmitted to the portable game device 200 via an infrared communication medium. A psychic picture image is created by using the shot image received by the portable game device 200. In FIG. 20, instead of the digital camera 100, a portable telephone 100B having a function of a telephone is used. In accordance with the demand for distributing a shot image, which is transmitted from a user with the portable telephone 100B, the shot image is distributed from a shot image distribution center HS to the portable telephone 100B via a telephone line, an optical cable, such as the Internet or the like, or a broadcast wave. The distributed shot image is transmitted to the portable game device 200B. By using the shot image received by the portable game device 200B, at least one game character relating data selected from the group consisting of a name of a character, a characteristic of the character, a color of the character, an attribute of the character and a name of a parameter used in the game, is automatically created and displayed, like the above-described embodiments.

Further, as shown in FIG. 20, the portable game device 200B having a function of a telephone is used. In accordance with the demand for distributing a shot image, which is transmitted from a user with the portable game device 200B having a function of the portable telephone, the shot image is distributed from a shot image distribution center HS to a receiving section 54C of the portable game device 200B having a function of the portable telephone via a telephone line, an optical cable, such as the Internet or the like, or a broadcast wave. By using the distributed shot image, at least one game character relating data selected from the group consisting of a name of a character, a characteristic of the character, a color of the character, an attribute of the character and a name of a parameter used in the game, may be automatically created and displayed on the portable game device 200B, like the above-described embodiments.

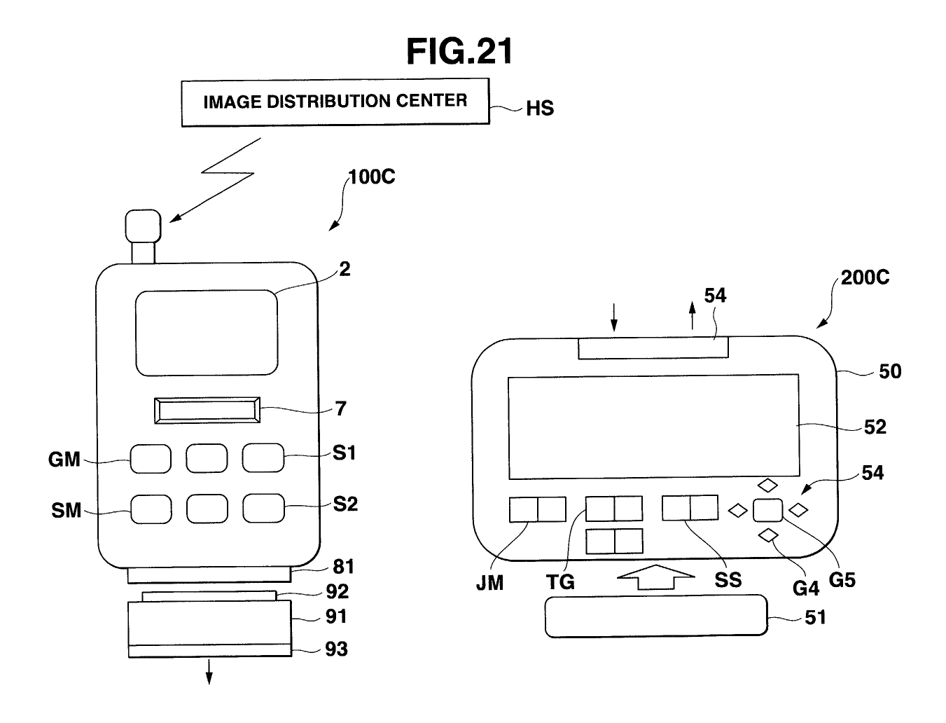

FIG. 21 shows further another embodiment of the present invention. In FIG. 21, an external adapter 91 having a function of the infrared communication therein, is detachably connected with a connection section 81 for connecting an external apparatus, which is provided on the lower portion of the portable telephone 100C. By using the portable telephone 100C, in accordance with the demand for distributing a shot image, which is transmitted from a user with the portable telephone 100C, the shot image is distributed from a shot image distribution center HS to the portable telephone 100C via a telephone line, an optical cable, such as the Internet or the like, or a broadcast wave. The distributed shot image is transmitted from the connection section 81 provided on the lower portion of the portable telephone 100C and an infrared communication section 93 of the external adapter 91 connected to the connection section 81 via a connection section 92, to an infrared communication section 54 of the portable game device 200C. By using the shot image received by the portable game device 200C, at least one game character relating data selected from the group consisting of a name of a character, a characteristic of the character, a color of the character, an attribute of the character and a name of a parameter used in the game, is automatically created and displayed, like the above-described embodiments.

In this embodiment, the electronic game system has a structure that the digital camera 100 and the portable game device 200 which are separated from each other, are connected with each other via a communication system. However, the function of the digital camera 100 and that of the portable game device 200 may be contained in one electronic game device case in order to provide an integrated electronic game device.

Further, as shown in FIG. 2, a data conversion ROM 59A and a game program ROM 58A which are the same as the data conversion ROM 59 (including the hit point conversion ROM 60 and the like) and the game program 58 which are provided in the portable game device 200, are provided in the digital camera 100. By using only the digital camera 100, at least one game character relating data selected from the group consisting of a name of a character, a characteristic of the character, a color of the character, an attribute of the character and a name of a parameter used in the game as shown in FIGS. 14 and 15, may be automatically created.

In contrast with the above description, as shown in FIG.2, various types of environment sensors, such as a timepiece section 11A, a positioning information obtaining section 12A, a compass (hereinafter, not shown in the figure), a weather sensor, a thermometer, a pedometer, an image capacity detecting section and the like, which are the same as various types of environment sensors, such as the timepiece section 11, the positioning information obtaining section 12, the compass 13, the weather sensor 14, the thermometer 15, the pedometer 16, the image capacity detecting section 17 and the like, which are provided in the digital camera 100, are provided in the portable game device 200. By using only the portable game device 200, at least one game character relating data selected from the group consisting of a name of a character, a characteristic of the character, a color of the character, an attribute of the character and a name of a parameter used in the game as shown in FIGS. 14 and 15, may be automatically created in accordance with the output data from these sensors.

In this embodiment, an electronic game is played by using the portable game device 200. However, at least one game character relating data selected from the group consisting of a name of a character, a characteristic of the character, a color of the character, an attribute of the character and a name of a parameter used in the game, may be automatically created by using an installed game device like the above-described embodiments.

Further, in this embodiment, a shot image is obtained by using the wrist watch type of digital camera 100. However, a shot image may be obtained by a portable telephone type of or a body attachment type of digital camera.

Further, in this embodiment, at least one game character relating data selected from the group consisting of a name of a character, a characteristic of the character, a color of the character, an attribute of the character and a name of a parameter used in the game, is automatically created in accordance with “numerical data”, such as the image data capacity, the shooting time and date and the like, which are obtained by the image capacity detecting section 17 and the timepiece section 11. However, instead of the above numerical data, at least one game character relating data selected from the group consisting of a name of a character, a characteristic of the character, a color of the character, an attribute of the character and a name of a parameter used in the game, may be automatically created in accordance with “numerical data which are environment data” detected by the positioning information obtaining section 12, the compass 13, the weather sensor 14, the thermometer 15, the pedometer 16 and the like, which are shown in FIG. 2.

In this embodiment, the “special skill name” is used as the name of the parameter used in the game. However, the name of the parameter is not limited to this. Another name of the parameter, such as “chemistry name”, may be used.

According to the embodiments, because at least one game character relating data selected from the group consisting of a name of a character, a characteristic of the character, a color of the character, an attribute of the character and a name of a parameter used in the game, is automatically created in accordance with the shot image, an interesting and unexpected game can be played certainly and rapidly.

As described above, in the electronic game device or system according to the present invention, at least one game character relating data selected from the group consisting of a name of a character, a characteristic of the character, a color of the character, an attribute of the character and a name of a parameter used in the game, can be certainly and rapidly created in accordance with the shot image transmitted from an electronic shooting device.

In the electronic game device according to the present invention, a shot image sent from the outside of the electronic game device is received. At least one game character relating data selected from the group consisting of a name of a character, a characteristic of the character, a color of the character, an attribute of the character and a name of a parameter used in the game, can be certainly and rapidly created in accordance with the received shot image.

Further, in the electronic game device according to the present invention, at least one game character relating data selected from the group consisting of a name of a character, a characteristic of the character, a color of the character,an attribute of the character and a name of a parameter used in the game, can be certainly and rapidly created in accordance with a stored shot image.

Further, in the electronic game device according to the present invention, while the game is executed in accordance with a stored game program data, at least one game character relating data selected from the group consisting of a name of a character, a characteristic of the character, a color of the character, an attribute of the character and a name of a parameter used in the game, can be certainly and rapidly created in accordance with the shot image stored in the storing section.

Further, in the storage medium according to the present invention, at least one game character relating data selected from the group consisting of a name of a character, a characteristic of the character, a color of the character, an attribute of the character and a name of a parameter used in the game, can be certainly and rapidly created in accordance with a shot image.

As a result, a game which is unexpected for a user, can be certainly and rapidly executed in accordance with a stored shot image.

What is claimed is:

1. An electronic game device comprising:
a receiving section for receiving a shot image sent from an outside of the electronic game device;
a shot image storing section for storing the shot image received by the receiving section; and
a creating section for automatically creating at least one game character relating data selected from the group consisting of a name of a character appearing in a game, a characteristic of the character, a color of the character, an attribute of the character and a name of a parameter used in the game, in accordance with the shot image stored in the shot image storing section.

2. The electronic game device as claimed in claim 1, further comprising:
a data storing section for relating the game character relating data created by the creating section to the character appearing in the game and for storing the game character relating data; and
a display control section for displaying the game character relating data stored in the data storing section and the character on a display section.

3. The electronic game device as claimed in claim 1, further comprising:
a game program storing section for storing a game program data; and
a display control section for displaying the shot image stored in the shot image storing section, on a display section as the character appearing in the game, and displaying the game character relating data which is automatically created in accordance with the shot image, while the game is executed in accordance with the game program data stored in the game program storing section.

4. The electronic game device as claimed in claim 3, wherein the display control section comprises:
an operation section for being manually operated by a user; and
a hidden character display control section for displaying the shot image stored in the shot image storing section, on the display section as a hidden character appearing in the game, and displaying the game character relating data which is automatically created in accordance with the shot image, after a predetermined time elapses since the operation section is manually operated while the game is executed.

5. The electronic game device as claimed in claim 1, wherein the creating section comprises a relating data creating section for automatically creating the game character relating data in accordance with any one of a data capacity of the shot image, a shooting month of the shot image, shooting month and day of the shot image, a shooting time slot of the shot image, shooting time and date of the shot image, and a shooting position of the shot image.

6. A data processing method for being used in an electronic game device, comprising the steps of:
receiving a shot image sent from an outside of the electronic game device;
storing the shot image received by the step of receiving; and
creating at least one game character relating data selected from the group consisting of a name of a character appearing in a game, a characteristic of the character, a color of the character, an attribute of the character and a name of a parameter used in the game, automatically in accordance with the shot image stored by the step of storing the shot image.

7. The data processing method as claimed in claim 6, further comprising the steps of:
relating the game character relating data created by the step of creating, to the character appearing in the game and storing the game character relating data; and
displaying the game character relating data stored by the step of storing the game character relating data, and the character.

8. The data processing method as claimed in claim 6, further comprising the step of:
displaying the shot image stored by the step of storing the shot image, on a display section as the character appearing in the game, and displaying the game character relating data which is automatically created in accordance with the shot image, while a game program storing section which stores a game program data is accessed and the game is executed in accordance with the game program data stored in the game program storing section.

9. The data processing method as claimed in claim 8, wherein the step of displaying comprises the step of:
displaying the shot image stored by the step of storing the shot image, on the display section as a hidden character, appearing in the game, and displaying the game character relating data which is automatically created in accordance with the shot image, after a predetermined time elapses since an operation section for being manually operated by a user is manually operated while the game is executed.

10. The data processing method as claimed in claim 6, wherein the step of creating comprises the step of creating the game character relating data automatically in accordance with any one of a data capacity of the shot image, a shooting month of the shot image, shooting month and day of the shot image, a shooting time slot of the shot image, shooting time and date of the shot image, and a shooting position of the shot image.

11. A storage medium storing a program therein, which is executable by a computer for controlling an electronic game device, the program comprises:
a first program code of receiving a shot image sent from an outside of the electronic game device;
a second program code of storing the shot image received by executing the first program code; and
a third program code of automatically creating at least one game character relating data selected from the group consisting of a name of a character appearing in a game, a characteristic of the character, a color of the character, an attribute of the character and a name of a parameter used in the game, in accordance with the shot image stored by executing the second program code.

12. The storage medium as claimed in claim 11, wherein the program further comprises:
a fourth program code of relating the game character relating data created by executing the third program code, to the character appearing in the game, and storing the game character relating data; and
a fifth program code of displaying the game character relating data stored by executing the fourth program code and the character on a display section.

13. The storage medium as claimed in claim 11, wherein the program further comprises:
a sixth program code of displaying the shot image stored by executing the second program code as the character appearing in the game, and displaying the game character relating data which is automatically created in accordance with the shot image, while a game program storing section which stores a game program data is accessed and the game is executed in accordance with the game program data stored in the game program storing section.

14. The storage medium as claimed in claim 13, wherein the sixth program code comprises:
a program code of displaying the shot image stored by executing the second program code as a hidden character appearing in the game, and displaying the game character relating data which is automatically created in accordance with the shot image, after a predetermined time elapses since an operation section for being operated by a user is manually operated while the game is executed.

15. The storage medium as claimed in claim 11, wherein the third program code comprises a program code of automatically creating the game character relating data in accordance with any one of a data capacity of the shot image, a shooting month of the shot image, shooting month and day of the shot image, a shooting time slot of the shot image, shooting time and date of the shot image, and a shooting position of the shot image.
